(19) United States
(12) Patent Application Publication
(10) Pub. No.: US 2009/0077209 A1
(43) Pub. Date: Mar. 19, 2009

(54) Particle therapy configuration

(76) Inventor: Michael Schneider, Erlangen (DE)

Correspondence Address: BRINKS HOFER GILSON & LIONE, P.O. BOX 10395, CHICAGO, IL, 60610, US

(21) Appl. No.: 12/232,287

(22) Filed: Sep. 11, 2008

(30) Foreign Application Priority Data
Sep. 19, 2007 (DE) 10 2007 044 630.8

(51) Int. Cl. G06F 15/177

(52) U.S. Cl. 709/222

(57) ABSTRACT

A particle therapy system is provided. The particle therapy system includes a plurality of spatially-distributed, configurable systems, which are operable to be configured using configuration data, a central configuration server that is operable to centrally store the configuration data, and a network that connects the configurable systems, with the central configuration server. The configurable systems include a local copy of the configuration data. The local copy of the configuration data may be accessed and used to configure one or more of the plurality of configurable systems.

The present patent document claims the benefit of the filing date of DE 10 2007 044 630.8 filed on Sep. 19, 2007, which is hereby incorporated by reference.

### BACKGROUND

The present embodiments relate to configuration of particle therapy system, in which a number of spatially-distributed configurable systems are used.

Spatially-distributed and configurable systems are used in a facility. In such a facility, a plurality of configuration data is used for these configurable systems, and some of this data overlap. Such a facility can be a particle therapy facility or system, for example.

A particle therapy system is used for treatment of tumor diseases. A particle therapy system may be a system with numerous rooms. Particles, which are used for radiation treatment, are generally created in a particle source, accelerated by a particle accelerator to the energies required for radiation treatment, and fed via a beam transport system to a treatment room. The treatment of a patient is undertaken in the treatment room.

A diversity of systems are usually used in such an particle therapy system, and the interaction of the systems provides correct operation of the system. Specific predefined settings may be used to place the configurable systems into a specific operating mode, which enables the system to be operated. This involves being able to configure the systems. The configurable systems access specific configuration data. Information technology (IT) systems, such as computer-aided systems, are normally used for this purpose.

Configuration data may be provided to each individual configurable system, for example, by a user entering the configuration data at each individual system.

US 2004/0164254 A1 discloses a particle therapy system using a configuration management system. The configuration management system includes a database, which includes data and configuration parameters, and a management component. Specific system control files are created from the subsets of the data of the database and are sent to selected devices, for example, magnet systems, for the configuration of these selected devices. The system control files are intended to capture single-point-of-failure events in the database and a guarantee safe operation.

The fact that a number of configurable systems and components are used in an system is, however, not just limited to particle therapy systems, but is also used in other systems, especially industrial systems, such as, for example, power stations or production systems or other systems in which spatially-distributed and configurable systems are used in which, depending on a desired special operating mode, specific settings must be made at the configurable systems.

### SUMMARY AND DESCRIPTION

The present embodiment may obviate one or more of the drawbacks or limitations inherent in the related art. For example, in one embodiment, a system with a number of spatially-distributed and configurable systems may be configured and maintained in a simple manner and with which safe and stable operation is possible at the same time.

In one embodiment, a particle therapy system includes a number of spatially-distributed, configurable systems, which are each embodied such that a setting for one of the configurable systems can be made with the aid of configuration data, a central configuration server, on which the configuration data is stored centrally, and networking of the configurable systems with the central configuration server. Each of the configurable systems includes a local copy of the configuration data that is stored on the central configuration server. The configurable systems are embodied such that, to make the setting, there is access to local stored configuration data, which is stored in the local copy of the configuration data.

A configurable system accesses that configuration data for making a setting, which is stored in the local copy of configuration data of this configurable system.

A system embodied in this manner has the advantage that configuration data is present as redundant data. Should an outage of the central configuration server occur, large parts of the system may still continue to be operated, since the configurable systems, to make a setting through configuration data, access the locally available copy of the configuration data in each case. Outages of the system, due to a failure or a failure of the central configuration server (i.e., a “single point of failure” event), are avoided.

A configurable system may include an IT system. Configuration data can be implemented with computer support using the IT system.

Since the configuration data in the configurable systems is present as a local copy of centrally-stored configuration data, the configurable systems can access an identical set of configuration data. If the configurable systems are networked, the configurable systems may communicate. Errors produced by configurable systems accessing different configuration data are avoided.

The central configuration server and the configurable systems for the system are embodied so that, for changes to the configuration data, a synchronization of the changed configuration data with the configuration data stored in the local copy may include the changed configuration data being sent from the central configuration server to the respective configurable systems, the reception of the changed configuration data being confirmed by the respective configurable systems, and an update of the local copy with the changed configuration data only being undertaken after all configurable systems have confirmed the receipt of the changed configuration data.

A simple and safe change and synchronization of the configuration data, for example, by a user, at the central configuration server is made possible. If a user changes the configuration data of a local copy of the compensation data, the changes can be passed to the central configuration server and the update of the configuration can be undertaken in the local copies as described.

A user can change configuration data at a central location. An update process, with the changed configuration data, can be safely executed such that the configurable systems always access an identical set of configuration data. The identical settings can be easily identified and consolidated, such that a configuration entry is made at one location at one IT system. This avoids the situation in which some of the configurable systems receive changed configuration data and different configuration data is inadvertently present at different systems. Configuration data is consolidated between different configurable systems in a simple way.

When one of the configurable systems fails and is to be replaced, the configurable system can be provided with all configuration data using a local copy of the configuration data of the central configuration server being created in the configurable systems. The system is able to be expanded in a similar way by further configurable systems. When a new configurable system is purchased at a later date and added to the system, the configuration data stored on the central configuration server can be made available to the new configurable system.

Since the configuration data is changed at a central location, the configuration data may be taken into account. If the result of selecting or changing specific configuration data is that the range of values for other configuration data of other systems changes, a check on this dependency at a single central location can be implemented. An inadvertent input of incorrect configuration data can be effectively caught.

In one embodiment, one of the configurable systems can be used as an independent configurable system with a local system of the server. The independently configurable system assumes the function of the central configuration server. This embodiment may be used, for example, when the system is designed for expansion and initially is to be operated with only one configurable system. The configurable system can serve later as a central configuration server for further configurable systems added to the system.

The configuration data may be stored both in a configuration server and the configurable systems in a database. The configurable systems include a local copy of the central stored database.

The system can comprise further configurable systems which, to make a setting, directly access the central stored configuration data of the central configuration server.

In one embodiment, a particle therapy system includes a particle source for creating particles, an accelerator unit for accelerating the particles and for forming a particle beam, at least one radiation treatment station, and a particle beam feed unit for conveying the particle beam from the accelerator to the at least one radiation treatment station. The accelerator unit and/or the particle beam feed unit are controlled by a control unit. The control unit, or a component of the control unit, is embodied in this case as a configurable system which has a local copy of the centrally stored configuration data. To control the accelerator unit and/or the particle beam feed unit the control unit or the components of the control unit access the locally stored configuration data. On the basis of a transfer of selected configuration data to the accelerator unit or particle beam feed unit, the control unit controls beam guidance of the particle beam to one of the available radiation treatment stations and/or having a desired beam quality.

In one embodiment, at each of the configurable systems, a local copy of the configuration data which is stored on the central configuration server is created, and the setting is implemented at one of the configurable systems in that the configuration data is accessed, which is stored in the local copy of the configuration data of this configurable system.

For a change of the configuration data stored on the central configuration server, a synchronization of the changed configuration data is executed with the local copy of the configuration data. The changed configuration data of the central configuration server is sent to the respective configurable systems. The reception of the configuration is confirmed by the respective configurable systems. The local copy, with the changed configuration data, is updated after the configurable systems have confirmed the receipt of the changed configuration data.

The configuration data stored on the central configuration server may be changed by the user during operation of the system.

### BRIEF DESCRIPTION OF THE DRAWINGS

FIG. 1 illustrates one embodiment of a particle therapy system; and

FIG. 2 illustrates one embodiment of a method for operating a system with a number of configurable systems.

### DETAILED DESCRIPTION

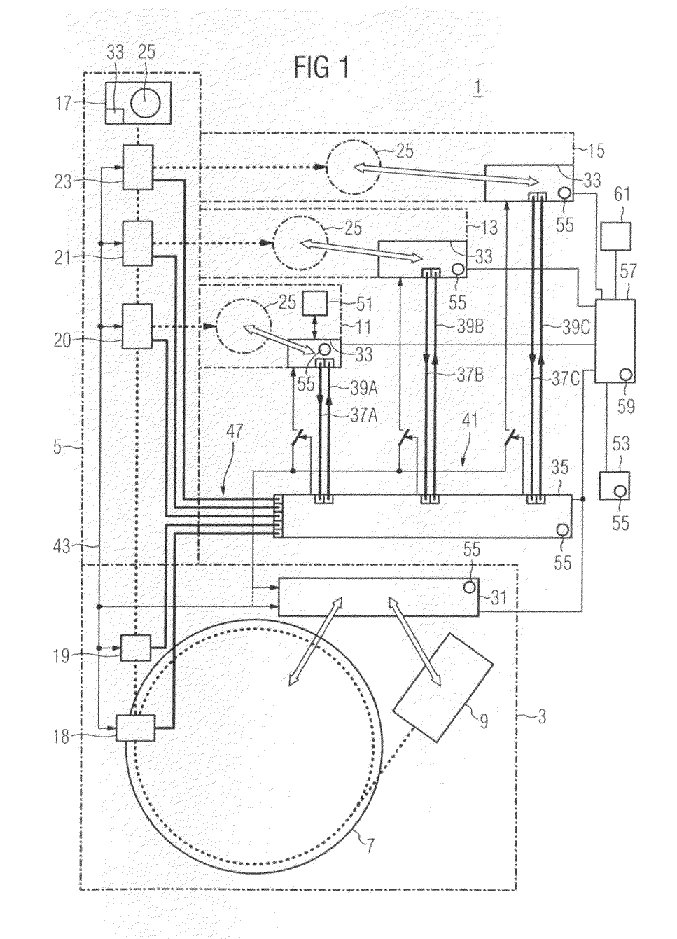

FIG. 1 illustrates a particle therapy system 1. Different systems are used in the particle therapy system, of which the interaction enables the correct operation of the particle therapy system 1.

The particle therapy system 1 features an accelerator unit 3 and a particle beam feed unit 5. The acceleration unit may include a synchrotron 7 with an upstream linear accelerator unit 9. The particle beam feed unit 5 feeds the accelerated particles and formed into a beam to one or more radiation treatment stations 11 . . . 15 or to a checking station 17.

FIG. 1 shows treatment stations 11, 13 and 15 for radiotherapy and a checking station 17 for ensuring the quality of the particle beam. Quality assurance is undertaken at the checking station 17 with the aid of quality procedures.

A coupling-out device 18 couples out accelerated particles in the accelerator unit 3, for example, in a synchrotron and coupled into the particle beam feed unit 5. The option of a fast beam deactivation after ending or interruption of the radiation process is undertaken, for example, by the insertion of a chicane 19, which is arranged after the extraction unit 18.

The particles are fed to the radiation treatment stations 11, 13 and 15 by the redirection of the particle beam by deflection magnets 20, 21 and 23 from a main beam unit in the particle beam feed unit 5. The checking station 17 is located in the main direction of the beam. The particles interact at the radiation treatment stations 11, 13, 15 and at the checking station 17 with a patient to be irradiated or a phantom in radiation zones 25. One of the radiation zones 25 is provided, for example, by a maximum scan area of a (raster) scan device, a maximum scatter area that can be irradiated, a scatter device, or an adjustable gantry radiation area.

A number of configurable systems are used in the particle therapy system 1.

One of these configurable systems is, for example, a component of a control unit for the accelerator unit 3 and/or the particle beam feed unit 5 of the particle therapy system 1. In the particle therapy system 1, the control unit may be divided into two components. A component of is, for example, an accelerator control unit 31. A further such component is, for example, an assignment unit 35.

The control unit 31, 35 for the accelerator unit 3 and/or the particle beam feed unit 5 take care of functions, such as the particle beam being fed to only that radiation treatment station 11 . . . 15 or checking station 17, which has actually requested it and that a requested particle beam of a predetermined specification arrives at the radiation treatment station 11 . . . 15 or checking station 17.

A configurable system may be a control unit 33. A control unit 33 may be located at a radiation treatment station 11 . . . 15 or checking station 17. A control unit 33 may ensure that the execution sequence of a radiation treatment process in accordance with a radiation treatment planning is executed at the assigned radiation treatment station.

A configurable system may be a radiation treatment planning station 53, at which a user can plan a radiation treatment to be undertaken and a radiation treatment plan 51 can be created. Such a radiation treatment plan is transmitted to the control unit 33.

The configurable systems are networked with each other and communicate with each other. Each of these configurable systems is capable of configuring components of the particle therapy system 1 in accordance with particular configuration data.

For example, the accelerator control unit 31 and the assignment unit 35 ensure that a requested particle beam arrives at the correct radiation treatment station 11 . . . 15 in accordance with a specification. The configuration data of the accelerator control unit 31 and of the assignment unit 35 is sent to the configurable beam guidance element. An implementation of a desired configuration of the beam guidance elements has the effect of ensuring correct beam guidance with the desired specifications. The beam guidance elements, for example, include the components of the particle beam feed unit 5 and the accelerator unit 3, such as the extraction unit 18, the chicane 19 and also the deflection magnets for example 20, 21, 23.

The assignment unit 35 sends an activation signal to the beam guidance elements necessary for correct beam guidance via permanently assigned signal connections 47, such as to the corresponding deflection magnets 20, 21, 23, for example. As soon as the activation signal is present at the beam guidance elements, configuration data sent from the accelerator control unit 31 to the beam guidance elements via a data bus system 43 can be implemented. Accordingly, the beam guidance elements necessary for the beam guidance may be set accordingly.

The assignment unit 35 receives from a control unit 33 of a radiation treatment station 11 . . . 15 a request signal about a fixed and uniquely assigned signal line 37A . . . 37C, 39A . . . 39C. The request signal notifies the assignment unit 35 in a unique manner of the treatment room 33, which is requesting the particle beam.

The configurable systems can communicate with each other. The configuration data accessed by the configurable systems is consistent, so that the configurable systems can communicate in a compatible way with each other.

The configurable systems include a local database 55 in which configuration data are stored. The local databases 55 are local copies of a central database 59 stored on a configuration server 57. The central configuration server has a user interface 61 via which a user can make settings at the central configuration server 57.

The configuration data may be stored, for example, in the local database 55 which is assigned to the assignment unit 35 or the accelerator control unit 31. The configuration data may be configuration data that the assignment unit 35 sends as an activation signal to the beam guidance elements necessary for correct beam guidance. The configuration data may be configuration data that the accelerator control unit 31 sends to the beam guidance elements for correct setting of the beam guidance elements.

The other configurable systems have a local database 55, which is a copy of the central database 59. The configurable systems access an identical set of configuration data. Accordingly, the configuration data is consistent when the configurable systems communicate directly with one another. Communication takes place, for example, if a radiation treatment station 11 . . . 15 requests a particle beam or if specifications for a particle beam are transferred from a therapy plan 51 through a control unit 33 via a further data bus system 41 to the accelerator control unit 31.

The fact that the configurable systems access the local database 55 enables safe operation of the particle therapy system 1 even if the central database 59 or a connection to the central database 59 is not available for a time. Accordingly, the operation of a particle therapy system 1 may be safe.

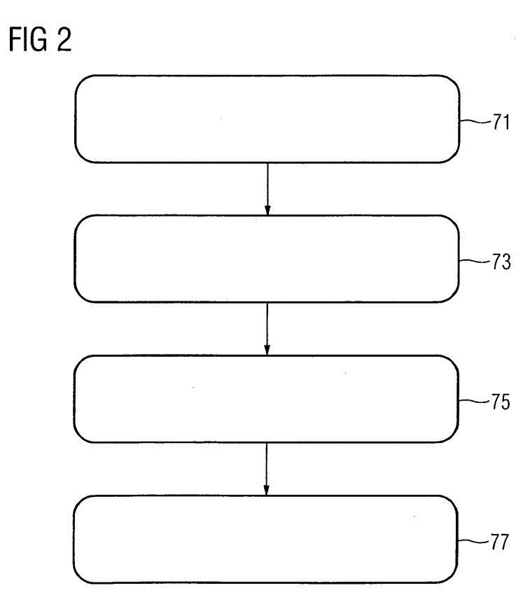

FIG. 2 shows method steps executed if a change to configuration data is undertaken. The configuration data (act 71) can be changed directly at the central database 59. When the configuration data at one of the local databases 55 is changed, the changed configuration data is transmitted to the central database 59.

The changed configuration data is transferred from the central configuration server 57 to the configurable systems, such as the assignment unit 35, the accelerator control unit 31, the control units 33, or the radiation treatment planning station 53 (act 73). After the transmission of the changed configuration data, the receipt of the changed configuration data is confirmed by configurable systems (act 75). The transferred changed configuration data is implemented and accepted into the local database 55 after successful confirmation of the correct receipt of the changed configuration data by the configurable systems (act 77). The databases, such as both the central database 59 and the local database 57, have the same set of configuration data available to them. Differing versions of the database are avoided, even if configuration data is changed by a user.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

1. A system, comprising:
a plurality of spatially-distributed, configurable systems, which are operable to be configured using configuration data,
a central configuration server that is operable to centrally store the configuration data, and
a network that connects the configurable systems with the central configuration server,
wherein the configurable systems include a local copy of the configuration data, and
wherein the local copy of the configuration data may be accessed and used to configure one or more of the plurality of configurable systems.

2. The system as claimed in claim 1, wherein the central configuration server and the configurable systems are operable to synch configuration data that is changed with the local copy of the configuration data when the configuration data is changed.

3. The system as claimed in claim 1, wherein the configuration data is stored on the central configuration server in a database, and the plurality of configurable systems have a local copy of the database.

4. The system as claimed in claim 1, further comprising: at least one additional configurable system, which is networked with the central configuration server, and with the additional configurable system being embodied such that a configuration in the additional configurable system can be made by accessing central configuration data stored on the central configuration server.

5. The system as claimed in claim 1, further comprising:
a particle source for creating particles,
an accelerator unit for accelerating the particles and for forming a particle beam,
at least one radiation treatment station,
a particle beam feed unit for guiding the particle beam from the accelerator unit to the at least one radiation treatment station,
wherein one of the plurality of configurable systems is a control unit for the acceleration unit and/or the particle beam feed unit, the control unit, on the basis of a transmission of local stored configuration data to the accelerator unit or particle beam feed unit, being operable to guide a particle beam to the at least one radiation treatment station and/or control a desired beam quality.

6. A method for configuring a plurality of spatially-distributed and configurable systems that are networked with a central configuration server, the method comprising:
creating a local copy of configuration data stored on the central server for each of the configurable systems, and configuring one of the configurable systems by accessing the configuration data in the local copy of the configuration data of the configurable systems.

7. The method as claimed in claim 6, further comprising:
changing the configuration data stored on the central configuration server; and
synchronizing the changed configuration data with the local copy of the configuration data.

8. A method for configuring a particle therapy system that includes a central server, a plurality of configurable systems, a particle source for creating particles, an accelerator unit for accelerating the particles and for forming a particle beam, at least one radiation treatment station, and a particle beam feed unit for guiding the particle beam from the accelerator unit to the at least one radiation treatment station, the method comprising:
creating a local copy of configuration data stored on the central server for each of the configurable systems, where one of the configurable systems is a control unit for the accelerator unit and/or the particle beam feed unit, the control unit being operable to ensure that a particle beam is guide to the at least one radiation treatment station and has a desired beam quality,
accessing configuration data, which is stored in the local copy of the configuration data of the control unit; and
transferring configuration data to the accelerator or the particle beam feed unit.

9. The particle therapy system as claimed in claim 2,
wherein the central configuration server is operable to send the changed configuration data to one or more respective configurable systems, and
wherein the configurable systems are operable to confirm receipt of the changed configuration data and update the copy of the configuration data with the changed configuration data after the plurality of configurable systems have confirmed the receipt of the configuration data.

10. The particle therapy system as claimed in claim 9, wherein the one or more respective configurable systems are configurable systems that are affected by the changed configuration data.

11. The method as claimed in claim 7, wherein synchronizing includes:
sending the changed configuration data from the central configuration server to one or more respective configurable systems;
